(19) United States
(12) Patent Application Publication
(10) Pub. No.: US 2009/0102854 A1
(43) Pub. Date: Apr. 23, 2009

(54) DISPLAY METHOD AND COLOR SEQUENTIAL DISPLAY

(75) Inventors: Chia-Cheng Lai, Tainan County (TW); Cheng-Hung Wu, Tainan County (TW); Chin-Cheng Liu, Tainan County (TW); Kuan-Hsu Fan-Chiang, Tainan County (TW); Cheng-Chi Yen, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HIMAX DISPLAY, INC., Tainan County (TW)

(21) Appl. No.: 12/254,838

(22) Filed: Oct. 21, 2008

Related U.S. Application Data
(63) Continuation-in-part of application No. 11/875,951, filed on Oct. 21, 2007.

(51) Int. Cl. G09G 5/02

(52) U.S. Cl. 345/589

(57) ABSTRACT

A display method and a color sequential display using the same are provided. The color sequential display displays a frame in a frame period, wherein the frame includes a plurality of sub-frames, and the frame period includes a plurality of sub-frame periods. In the display method, a first sub-frame is displayed in response to a luminaire device during a first sub-frame period, and in simultaneous, a second sub-frame is addressed in the first sub-frame period. Next, the second sub-frame is displayed in response to the luminaire device during a second sub-frame period. In the display method, scales of the first sub-frame period and the second sub-frame period are determined according to the luminous efficiency of the luminaire device. Therefore, the optical performance of the color sequential display can be enhanced.

### CROSS-REFERENCE TO RELATED APPLICATION

This application is a continuation-in-part of a prior application Ser. No. 11/875,951, filed Oct. 21, 2007. The entirety of the above-mentioned patent application is hereby incorporated by reference herein and made a part of this specification.

### BACKGROUND OF THE INVENTION

1. Field of the Invention

The present invention relates to a display method and a color sequential display using the same, more particularly, to a display method that adjusts scales of different color frame periods for displaying.

2. Description of Related Art

Along with the maturation of photoelectric technology and semiconductor manufacturing technology, flat panel displays are developed rapidly. Liquid crystal displays (LCD) advantageous in low-voltage operation, no-radiation, light weight, and small volume have gradually replaces conventional cathode-ray tube displays to become mainstream display products in the market. An LCD is mainly constituted by an LC panel and a backlight module. As liquid crystals injected into the LC panel do not emit light by themselves, the LC panel must be lightened by a plane light source provided by the backlight module, so as to enable the LCD to display.

Traditionally, a white light source, e.g. cold cathode fluorescent lamp (CCFL), is configured in the backlight module for displaying different colors through color filters disposed on each pixel region. There are three color filters, e.g. red, green and blue, disposed on each pixel region for mixing colors in spatial domain. As a result, not only increases manufacturing cost, but also have poor light transmission through the color filters. In addition, a color deviation would be perceived by human eyes in boundaries between those color filters, so that a black matrix is employed to separate the color filters for improving the color deviation problem, but the light transmission is decreased all the more by the black matrix.

In recent year, light emitting diodes (LEDs) are gradually used to replace the conventional white light source for displaying different colors of a pixel. Instead of mixing colors in spatial domain, three primary colors of light, e.g. red, green and blue, emitted by the LEDs are mixed in temporal domain. In other word, these colors are rapidly switched to display within visual staying time of human eyes. Hence, there is no need to dispose the color filters, and the light transmission can be efficiently increased.

FIG. 1 is a diagram of a color sequential display method. Referring to FIG. 1, a frame includes a red (R) sub-frame, a green (G) sub-frame and a blue (B) sub-frame, which are respectively displayed during equal sub-frame periods T_{R}, T_{G} and T_{B} composing a frame period. When the red sub-frame is displayed during the sub-frame period T_{R}, red data are first transmitted to a source driver. The source driver converts the red data into driving voltages and then delivers the driving voltages to corresponding pixels within a data transmission time t_{DR}. In the meanwhile of delivering the driving voltages to pixels on a display panel, the orientation direction of liquid crystal (LC) is changed in response to the driving voltages, so that a LC response time t_{LC} is necessary for phase transition of LC. After the LC response time t_{LC}, the red LEDs of the backlight module are lighted up for an optical display time t_{BR} to provide a red backlight to the display panel so as to display the red sub-frame. To reason by analogy, the green sub-frame and the blue sub-frame are sequentially displayed during the sub-frame periods T_{G} and T_{B}.

With regard to the identical optical display times t_{BR}, t_{BG} and t_{BB}, brightness of the red, green and blue backlight are different in accordance with currents for driving different color LEDs, and light transmissions of LC corresponding to different color backlights. As a result, the frame may not be displayed under a preset white balance. People previously mentioned that there are two methods for adjusting the frame to reach the preset white balance.

In the first method, the brightness of one of the red, green and blue backlights is adjusted to the maximum, and the others are decreased to reach the preset white balance. Nevertheless, as being limited by the attenuated brightness of the backlights, the light source can not exert its optimal performance. In the second method, under the circumstance that the sub-frame periods T_{R}, T_{G} and T_{B} are identical, one of the optical display times t_{BR}, t_{BG} and t_{BB} is adjusted to the maximum, and other optical display times are decreased to reach the preset white balance. The utilization efficiency of the light source is decreased since the idle time in the sub-frame period can not be efficiently utilized. Besides, the brightness of light perceived by human eyes is related to the duration of the backlight, so that the decrement of the optical display time may cause the displayed frame to have lower brightness.

### SUMMARY OF THE INVENTION

Accordingly, the present invention provides a display method that can enhance the optical performance and the work efficiency of a color sequential display. In addition, the present invention also provides the color sequential display using the said display method.

A display method for a color sequential display to display a frame in a frame period is provided. The frame includes a plurality of sub-frames, and the frame period includes a plurality of sub-frame periods. In the display method, a first sub-frame is displayed during a first sub-frame period in response to a luminaire device, and in simultaneous, a second sub-frame is addressed during the first sub-frame period. Next, the second sub-frame is displayed during a second sub-frame period in response to the luminaire device. The scales of the first sub-frame period and the second sub-frame period are determined according to the luminous efficiency of the luminaire device.

In an embodiment of the foregoing display method, a first illumination and a second illumination associated with the luminaire device are provided during the first sub-frame period and the second sub-frame period respectively.

In an embodiment of the foregoing display method, the second sub-frame is addressed according to a clock signal with a clock frequency during the first sub-frame period, wherein the clock frequency has an inverse proportion relation to the scale of the first sub-frame period.

In an embodiment of the foregoing display method, the first sub-frame period and the second sub-frame period are determined according to a color temperature corresponding to the displayed frame.

A color sequential display is provided in the present invention. The color sequential display displays a frame in a frame period, wherein the frame includes a plurality of sub-frames, and the frame period includes a plurality of sub-frame periods. The color sequential display includes a data driver, a luminaire device, a control module and a display panel. The data driver respectively addresses a first sub-frame, a second sub-frame and a third sub-frame according to a clock signal during a first sub-frame period, a second sub-frame period and a second sub-frame period. The luminaire device respectively provides a first illumination, a second illumination and a third illumination according to a control signal during the first, the second and the third sub-frame periods. The control module respectively provides the clock signal and the control signal to the data driver and the luminaire device. The display panel respectively displays the first and the second sub-frames in response to the luminaire device during the second and the third sub-frame periods. The scales of the first, the second and the third sub-frame periods are determined according to the luminous efficiency of the luminaire device.

In an embodiment of the foregoing color sequential display, the control module further includes a timing controller. The timing controller generates the clock signal having a clock frequency to the data driver, wherein the clock frequency is adjustable according to the scales of the sub-frame periods.

In an embodiment of the foregoing color sequential display, the control module further includes an efficiency controller. The efficiency controller generates the control signal according to the luminous efficiency of the luminaire device.

The present invention provides the display method and the color sequential display that refer the luminous efficiency of the luminaire device to determine the scales of the sub-frame periods. For achieving optimal luminous efficiency, the illuminations provided by the luminaire device and the scales of the sub-frame periods are adjusted since brightness perceived by human eyes is related to both of them. Hence, the optical performance and the word efficiency of the color sequential display can be enhanced.

In order to make the aforementioned features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a color sequential display method.

FIG. 2A is a block diagram of a color sequential display according to an embodiment of the present invention.

FIG. 2B is a diagram of a display method for the color sequential display according to the embodiment of FIG. 2A.

FIG. 3 is a curve diagram of the luminous efficiency changing as current of driving the luminaire device according to the embodiment of FIG. 2A.

FIG. 4 is a diagram of adjusting the sub-frame periods according to the embodiment of FIG. 2A.

FIG. 5 is a diagram of adjusting the sub-frame periods according to the embodiment of FIG. 2A.

FIG. 6 is a diagram of data addressing according to another embodiment of the present invention.

FIG. 7 is a diagram of data addressing according to another embodiment of the present invention.

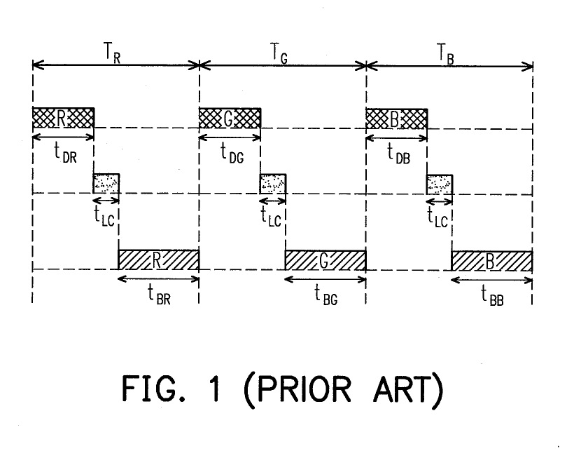

### DESCRIPTION OF EMBODIMENTS

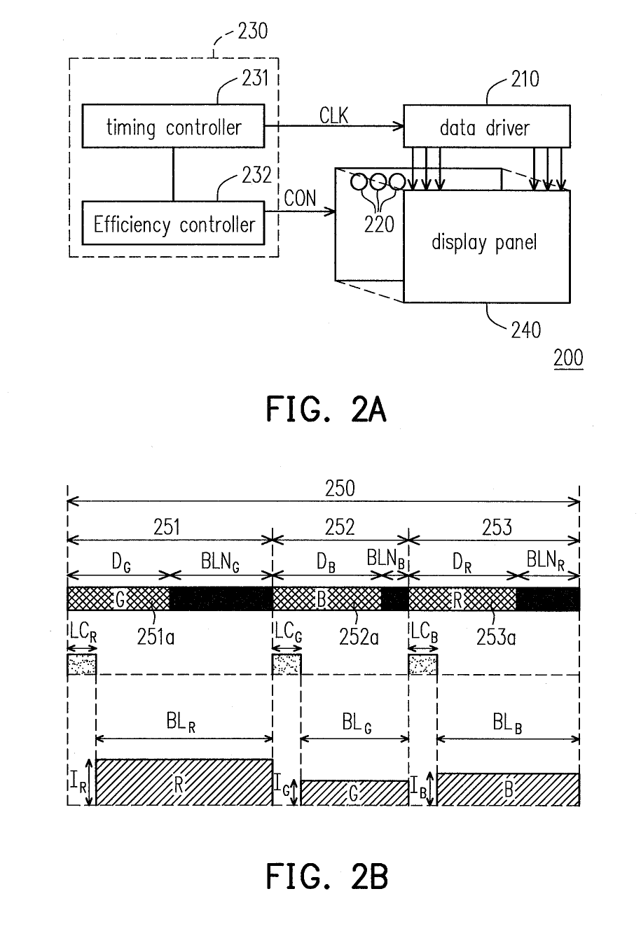

FIG. 2A is a block diagram of a color sequential display according to an embodiment of the present invention. FIG. 2B is a diagram of a display method for the color sequential display in the embodiment of FIG. 2A. Referring to FIG. 2A and FIG. 2B, the color sequential display 200 displays a frame during a frame period 250. The frame includes a plurality of sub-frames with different colors, e.g. red (R) sub-frame, green (G) sub-frame and blue (B) sub-frame, and these sub-frames are switched to display in axis of time (or called in the temporal domain). In order word, these sub-frames are respectively displayed during a plurality of sub-frame periods of the frame period 250. There are only three sub-frame periods 251 through 253 shown in the FIG. 2B, and the number of the sub-frame period is equivalent to the number of the sub-frame.

The color sequential display 200 includes a data driver 210, a luminaire device 220, a control module 230 and a display panel 240. In the embodiment of the present invention, it is assumed that the sub-frames of red, green and blue are sequentially displayed, and the display 200 has frame buffer architecture for pre-storing the following sub-frame data. The data driver 210 respectively addresses data of the green sub-frame 251a, the blue sub-frame 252a and the red sub-frame 253a during the sub-frame periods 251 through 253. For example, the data driver 210 simultaneously addresses the data of the green sub-frame 251a when the red sub-frame is displayed during the sub-frame period 251, and then the data driver 210 simultaneously addresses the data of the blue sub-frame 252a when the green sub-frame is displayed during the sub-frame period 252. Hence, the data of each sub-frame can be pre-stored by the data driver 210 and displayed thereafter.

The luminaire device 220, e.g. light emitting diode (LED), respectively provides different color backlights with a first illumination I_{R}, a second illumination I_{G} and a third illumination I_{B} to the display panel 240 according to a control signal CON during the sub-frame periods 251 through 253. As for displaying each sub-frame, each sub-frame period includes a liquid crystal (LC) response time and an optical display time of lighting the luminaire device 220. When the red sub-frame is displayed during the sub-frame period 251, the data of the red sub-frame, which has been addressed by the data driver 210 during the sub-frame period previous to the sub-frame period 251, are delivered to the display panel 240 for driving the pixels, meanwhile, the orientation direction of liquid crystal (LC) disposed in the display panel 240 changes for the LC response time LC_{R}. Then, the luminaire device 220 is lighted up for the optical display time BL_{R} to provide the red backlight with the first illumination I_{R} to the display panel 240 according to the control signal CON. Similarly, analogies can be drawn to display the green sub-frame and the blue sub-frame. In the embodiment of the present invention, the scales of the sub-frame periods 251 through 253 are adjusted in accordance with a luminous efficiency of the luminaire device 200 for enhancing the optical performance of the color sequential display 200.

The control module 230 includes a timing controller 231 and an efficiency controller 232. The timing controller 231 generates the clock signal CLK to the data driver 210, and the efficiency controller 232 generates the control signal CON to the luminaire device 220 according to the luminous efficiency of the luminaire device 220. The display panel 240 respectively displays the red sub-frame, the green sub-frame and the blue sub-frame in response to the luminaire device 220 during the sub-frame periods 251 through 253.

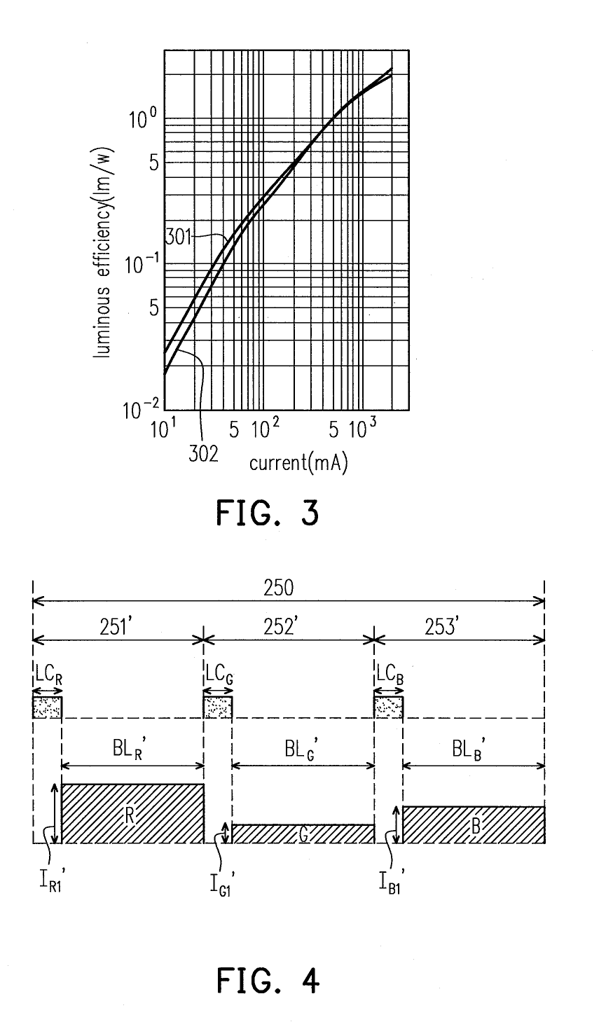

FIG. 3 is a curve diagram of the luminous efficiency changing as current of driving the luminaire device 220 in the embodiment of FIG. 2A. Referring to FIG. 3, the logarithm of the current to the decimal base and the logarithm of the luminous efficiency to the decimal base are respectively shown in the axes of horizontal and vertical. The curve 301 and the curve 302 are respectively related to the luminaire devices emitting the backlights of green and blue. As the current increases, the tendency of the luminous efficiency of the luminaire device 220 also increases in a non-linear way. However, the tendency of the luminous efficiency of the luminaire device 220 increases slowly once the current reaches to a specific level. It means that even if the current is substantially increased, the increment of the luminous efficiency is restricted. Hence, in order to enhance optical performance, the luminous efficiency of the luminaire device 220 should be taken into consideration to adjust the scales of the sub-frame periods 251 through 253.

FIG. 4 is a diagram of adjusting the sub-frame periods according to the embodiment of FIG. 2A. It is assumed that a white color of the frame displayed by the color sequential display 200 has a slight green tint. Referring to FIG. 4, for convenience of description, the original first illumination I_{R1}′ and the original second illumination I_{G1}′ are same as the third illumination I_{B1}′. Under circumstances that the sub-frame periods 251′ through 253′ are identical, the first illumination I_{R1}′ of the red backlight should be increased and the second illumination I_{G1}′ of the green backlight should be decreased for achieving white balance, wherein the illumination is related to the current driving the luminaire device 220. Since the brightness of light perceived by human eyes is related to the magnitude of the backlight (i.e. the illumination) and the duration of the backlight (i.e. the optical display time), an identical brightness of light can be obtained by trading off between the magnitude of the backlight and the duration of the backlight.

Referring to FIG. 2B and FIG. 4, the efficiency controller 232 increases the sub-frame period 251′ (as the sub-frame period 251 is shown) to trade for the lower first illumination I_{R} of the red backlight (i.e. I_{R}<I_{R1}′) according to the luminous efficiency of the luminaire device 200. The efficiency controller 232 decreases the sub-frame period 252′ (as the sub-frame period 252 is shown) to trade for the higher second illumination I_{G} of the green backlight (i.e. I_{G}>I_{G1}′) according to the luminous efficiency of the luminaire device 200. Accordingly, the first illumination I_{R} and the second illumination I_{G} are determined according to the luminous efficiency of the luminaire device 200. The LC response times LC_{R}, LC_{B} and LC_{G} can be seen as the same, so that the increment (or decrement) of each sub-frame period is equivalent to the increment (or decrement) of the optical display time of lighting the luminaire device 200. The efficiency controller 232 generates the control signal CON for controlling the luminaire device 200 to provide proper illumination.

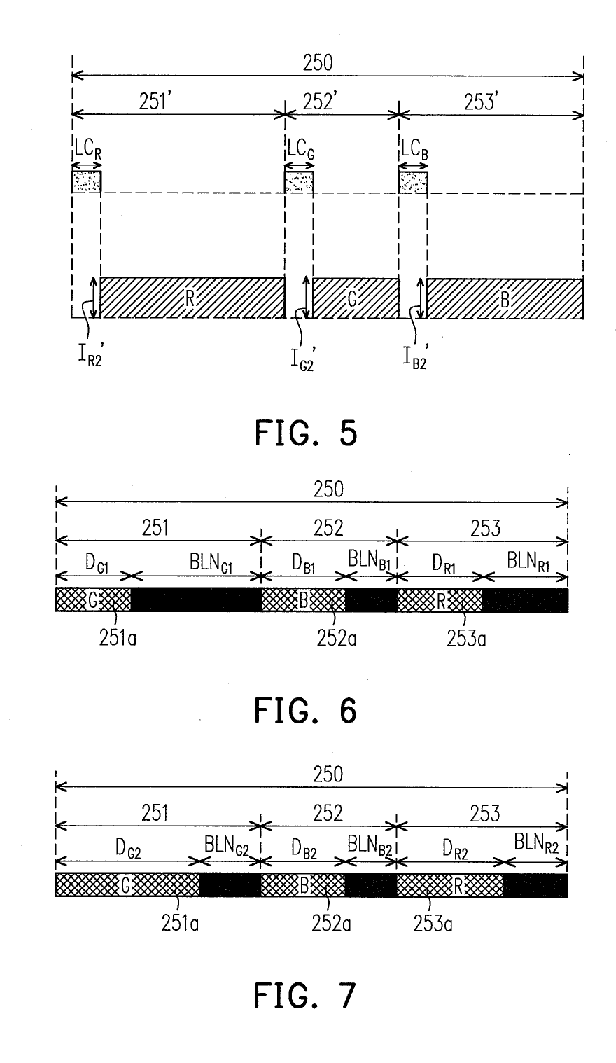

Furthermore, there is another embodiment for teaching people ordinarily skilled in the art to practice the present invention. FIG. 5 is a diagram of adjusting the sub-frame periods according to the embodiment of FIG. 2A. Generally, a color temperature is a significant characteristic of visible light, and the color perceived by human eyes varies with the color temperature. The color temperature can be referred to adjust the sub-frame periods, so that the adjustment of the embodiment can be adapted to different light sources. Referring to FIG. 5, for convenience of description, the original sub-frame periods 251′ and 252′ are same as the sub-frame period 253′. In the said assumption that the displayed frame has the slight green tint, the efficiency controller 231 increases the sub-frame period 251′ and decreases the sub-frame period 252′ according to the color temperature corresponding to the displayed frame for achieving white balance.

Then, referring to FIG. 2B and FIG. 5, the efficiency controller 232 slightly decreases the sub-frame period 251′ (as the sub-frame period 251 is shown) to trade for the higher first illumination I_{R} of the red backlight (i.e. I_{R}>I_{R2}′) according to the luminous efficiency of the luminaire device 220. In addition, the efficiency controller 232 slightly increases the sub-frame period 252′ (as the sub-frame period 252 is shown) to trade for the lower second illumination I_{G} of the green backlight (i.e. I_{G}<I_{G2}′) according to the luminous efficiency of the luminaire device 220.

As the foregoing description of the embodiments in FIG. 4 and FIG. 5, it is clearly known that the scales of the sub-frame periods and the illuminations of the luminaire device 220 are determined according to the luminous efficiency of the luminaire device 220. The color sequential display 200 in the embodiment provides a higher brightness without sacrificing the utilization efficiency of the luminaire device 220. For example, the time decrement of the sub-frame period 252 is utilized for increasing the duration of the red backlight. Besides, the color sequential display 200 achieves white balance by regulating the scales of the sub-frame period according to the luminous efficiency of the luminaire device 220, so that the optical performance and the work efficiency of the color sequential display 200 can be enhanced.

Since the sub-frame periods are adjustable, a proper timing control should be well designed to ensure that the time for the data driver 210 to address the data of the sub-frames is sufficient. As for data addressing, each sub-frame period includes a data transmission time and a blank time. The data transmission time is determined according to a clock frequency of the clock signal CLK, and the blank time is determined according to the resolution of the display panel 240.

Referring to FIG. 2B, when the red frame is displayed during the sub-frame period 251, the data driver 210 simultaneously addresses the data of the green sub-frame 251a according to the clock signal CLK during the data transmission time D_{G} of the sub-frame period 251. The blank time BLN_{G} contains the time for scanning from the end of each row of the display panel 240 to the beginning of the next row of the display panel 240, the time for scanning from the end of the last row of the display panel 240 to the beginning of the first row of the display panel 240, and the time for signal processing. Similarly, analogies can be drawn to address the data of the blue sub-frame and the red sub-frame.

In the embodiment of the present invention, the data of the green sub-frame 251a, the blue sub-frame 252a and the red sub-frame 253a are addressed by the data driver 210 according to the clock signal CLK with a preset clock frequency, so that the data transmission times D_{G}, D_{B} and D_{R} are the same. Since the sub-frame period 252 is relatively shorter than the sub-frame periods 251 and 253, the blank time BLN_{B} is reduced to obtain sufficient data transmission time D_{B} in the embodiment of the present invention.

FIG. 6 is a diagram of data addressing according to another embodiment of the present invention. Referring to FIG. 6 and FIG. 2B, since the blank time can not be unrestrictedly decreased, the data of the green sub-frame 251a, the blue sub-frame 252a and the red sub-frame 253a in FIG. 6 are addressed by the data driver 210 according to a clock frequency higher than the preset clock frequency of the said embodiment in FIG. 2B. Therefore, the data transmission times D_{G1}, D_{B1} and D_{R1} are the same and shorter than the transmission times D_{G}, D_{B} and D_{R}. The data addressing in the embodiment of the present invention can be adapted to the scales of the sub-frame periods.

FIG. 7 is a diagram of data addressing according to another embodiment of the present invention. Referring to FIG. 7 and FIG. 2B, the data of the green sub-frame 251a, the blue sub-frame 252a and the red sub-frame 253a are addressed by the data driver 210 according to the clock signal CLK with variable clock frequency. For example, the sub-frame period 251 is relatively longer than the sub-frame periods 252 and 253, so that the green sub-frame 251a is addressed by the data driver 210 according to a clock frequency smaller than the preset clock frequency of the said embodiment in FIG. 2B, and the data transmission time D_{G2} is longer than the data transmission time D_{G}. In addition, the sub-frame period 252 is relatively shorter than the sub-frame period 251 and 253, so that the blue sub-frame 252a is addressed by the data driver 210 according to the clock frequency higher than the preset clock frequency of the said embodiment in FIG. 2B, and the data transmission time D_{B2} is shorter than the data transmission time D_{B}. The red sub-frame 253a is addressed by the data driver 210 according to the preset clock frequency. Accordingly, the clock frequency of the clock signal CLK can be varied according to an inverse proportion relation to the scale of each sub-frame period.

It is noted that although there are only three sub-frames described in the said embodiments, people ordinarily skilled in the art can utilize more or less sub-frames than the said embodiment to perform the color sequential display method. For example, in the temporal domain, the sub-frames of red, green, blue and white (or black) can be switched to display during the frame period. Therefore, the present invention is not limited to the displaying order of the sub-frames, the number of the sub-frames and colors of the sub-frames.

In summary, the said embodiments in FIG. 2A and FIG. 2B provide the display method and the color sequential display that determine the scales of the sub-frame periods and the illuminations provided by the luminaire device according to the luminous efficiency of the luminaire device. Therefore, the optical performance of the color sequential display can be enhanced, so does the work efficiency of the color sequential display. In the display method, when one of the sub-frames is displayed during the corresponding sub-frame period, the data of the next sub-frame is simultaneously addressed during the same sub-frame period. Since the sub-frame periods are adjustable, the said embodiments in FIG. 2B, FIG. 6 and FIG. 7 provide different methods for ensuring the operation of data addressing is correct, e.g. reducing the blank time or adjusting the clock frequency of the clock signal.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A display method, for a color sequential display to display a frame in a frame period, wherein the frame comprises a plurality of sub-frames, and the frame period comprises a plurality of sub-frame periods, the display method comprising:
displaying a first sub-frame in response to a luminaire device during a first sub-frame period;
simultaneously addressing a second sub-frame during the first sub-frame period; and
displaying the second sub-frame in response to the luminaire device during a second sub-frame period;
wherein the scales of the first sub-frame period and the second sub-frame period are determined according to the luminous efficiency of the luminaire device.

2. The display method as claimed in claim 1, further comprising:
providing a first illumination associated with the luminaire device during the first sub-frame period; and
providing a second illumination associated with the luminaire device during the second sub-frame period.

3. The display method as claimed in claim 2, wherein said providing step further comprises:
determining the first illumination and the second illumination according to the luminous efficiency of the luminaire device.

4. The display method as claimed in claim 1, wherein said addressing step further comprising:
addressing the second sub-frame according to a clock signal having a clock frequency during the first sub-frame period;
wherein the clock frequency is determined according to the scales of the first sub-frame period.

5. The display method as claimed in claim 4, wherein the clock frequency has an inverse proportion relation to the scale of the first sub-frame period.

6. The display method as claimed in claim 1, wherein the scales of the first sub-frame period and the second sub-frame period are determined according to a color temperature corresponding to the displayed frame.

7. The display method as claimed in claim 1, wherein each of the sub-frames of the displayed frame is respectively corresponding to a color.

8. The display method as claimed in claim 1, wherein the luminaire device is an LED luminaire.

9. A color sequential display for displaying a frame in a frame period, wherein the frame comprises a plurality of sub-frames, and the frame period comprises a plurality of sub-frame periods, said display comprising:
a data driver, for respectively addressing a first sub-frame, a second sub-frame, and a third sub-frame according to a clock signal during a first sub-frame period, a second sub-frame period, and a third sub-frame period;
a luminaire device, for respectively providing a first illumination, a second illumination, and a third illumination according to a control signal during the first sub-frame period, the second sub-frame period, and the third sub-frame period;
a control module, for respectively providing the clock signal and the control signal to the data driver and the luminaire device.
a display panel, for respectively displaying the first sub-frame and the second sub-frame in response to the luminaire device during the second sub-frame period and the third sub-frame period;
wherein the scales of the first sub-frame period, the second sub-frame period, and the third sub-frame period are determined according to the luminous efficiency of the luminaire device.

10. The display as claimed in claim 9, wherein the control module further comprises:
a timing controller, for generating the clock signal having a clock frequency to the data driver.

11. The display as claimed in claim 10, wherein the clock frequency of the clock signal is adjustable according to the scales of the sub-frame periods.

12. The display as claimed in claim 11, wherein the clock frequency of the clock signal has an inverse proportion relation corresponding to the scales of the sub-frame periods.

13. The display as claimed in claim 9, wherein the control module further comprises:
an efficiency controller, for generating the control signal according to the luminous efficiency of the luminaire device.

14. The display method as claimed in claim 9, wherein the scales of the first sub-frame period, the second sub-frame period, and the third sub-frame period are determined according to a color temperature corresponding to the displayed frame.

15. The display as claimed in claim 9, wherein each of the sub-frames of the displayed frame is respectively corresponding to a color.

16. The display as claimed in claim 9, wherein the luminaire device is an LED luminaire.
